(19) United States
(12) Patent Application Publication
(10) Pub. No.: US 2013/0213275 A1
(43) Pub. Date: Aug. 22, 2013

(54) METHOD OF FORMING STRUCTURE UTILIZING A HYDRATED LIME MATERIAL

(71) Applicants: Gregory S. Hein, Katy, TX (US); Sun Yong Kim, Hayward, CA (US)

(72) Inventors: Gregory S. Hein, Katy, TX (US); Sun Yong Kim, Hayward, CA (US)

(21) Appl. No.: 13/420,199

(22) Filed: Mar. 14, 2012

Related U.S. Application Data
(63) Continuation-in-part of application No. 13/397,769, filed on Feb. 16, 2012.

(51) Int. Cl. C04B 18/06; C04B 2/02

(52) U.S. Cl. 106/710; 106/800; 106/793

(57) ABSTRACT

A method of forming structures utilizing a hydrated lime material. A hydrated lime material is formed that is impermeable to water that is formed by subjecting a quicklime to a mixer and adding a surfactant and water to form the hydrated lime. The hydrated lime is then blended with a composite material to form a blended material that is impermeable to water. This blended material is then utilized in differing structures in order to form structures that are impermeable to water.

### CROSS REFERENCE TO A RELATED APPLICATION

This application is a continuation-in-part of U.S. patent application Ser. No. 13/397,769 filed Feb. 16, 2012.

### BACKGROUND OF THE INVENTION

“Lime” is a general term used for calcium-containing inorganic materials, in which carbonates, oxides and hydroxides predominate. Lime is used in large quantities as building and engineering materials (including limestone products, concrete and mortar) and as chemical feedstock, among other uses. Lime is typically derived from mined limestone or chalk, which are composed primarily of calcium carbonate. These rocks may be crushed or pulverized and chemically altered through various processes. “Burning” (calcination) converts lime into the highly caustic material known as “quicklime” (calcium oxide, CaO). Through subsequent addition of water, quicklime is converted into the less caustic (but still strongly alkaline) slaked lime or hydrated lime (calcium hydroxide, Ca(OH)2). The process of converting quicklime to slaked lime or hydrated lime is called slaking of lime.

The chemical reactions describing the production of high calcium or dolomitic based lime hydrate are as follows:

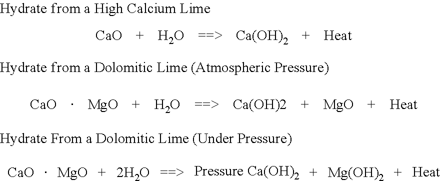

Quite often the terms Hydrated Lime and Slaking are used interchangeably; however there is a definite and distinct difference between the two terms. Hydrated Lime is defined as a process whereby approximately stoichiometric amounts of water and lime react to form a product, hydrate, which is a dry powder; i.e. it contains less than 1% free moisture and is handled as a powder. In contrast, slaking is defined as a process whereby lime is reacted with an excess amount of water to form a lime slurry which is handled as a liquid. Hydrated lime is a very well-known and understood material that has been used for many years as an additive into many different industrial applications. It is formed when quicklime or calcium oxide (CaO) comes into contact with water. When water is added to quicklime an exothermic reaction takes place which converts the CaO to Ca(OH)₂. This exothermic reaction is known to drive off the water the calcium oxide reacts with in a very extreme rise in temperature while releasing evaporated water. Once the material has reacted it becomes very stable and is thereafter used in many applications from civil engineering work, additives in food, to stabilize soils and foundations, and the like.

The quality of raw lime materials vary with the quality of the rock formations from which it is mined. Limestone deposits differ in quality by many aspects. One of the most measurable differences is the magnesium content of the deposit. As magnesium content increases to higher levels, a different grade of lime is the end result. This high magnesium content lime is called “dolomitic lime” and is preferred in the production of certain end products.

The production of hydrated lime starts at a limestone quarry. The limestone, CaO₃, is mined as a mineral from the characteristic quarry for the desired final product use. The limestone is processed to a fineness required for the energy intensive kiln process wherein CO₂ is driven off and the result is a fine white product comprised mostly of CaO and a percentage of MgO (dependent on the mineral deposit within the quarry). Since the CaO and MgO are very reactive with water, the material is either immediately hydrated on site at a hydration facility or stored in a low moisture environment.

There are many lime hydration facilities throughout the world. Although there are many specific and unique ways to hydrate specific quicklime, the most common ways involve one of two types of process. The first is a non-pressure environment which is most commonly used for high calcium quicklime where the magnesium oxide content is less than 7%. The second involves high pressure process wherein the higher magnesium oxide content limes (where the magnesium oxide content is more than 7%) are hydrated more fully than without the use of pressure.

The amount of pressure can be modified to aid in the hydration of the MgO, which is harder to hydrate than CaO. In addition, the amount of water that can also be modified to aid in the hydration process. Slaking is often used for the process which involves the use of greater than stoichiometric amounts of water beyond what is needed for the full reaction and results in a liquid-lime slurry.

The improved process is a modification to the dry hydration process.

### BRIEF SUMMARY OF THE INVENTION

A method of forming structures utilizing a hydrated lime material that includes the steps of forming a hydrated lime. The hydrated lime is formed by subjecting quicklime to a mixer and then adding a surfactant mixture and water until a hydrated lime material that is impermeable to water is created. The hydrated lime is then blended with a composite material to form a blended material that is used to form structures that effectively are impermeable to water.

### BRIEF DESCRIPTION OF THE DRAWINGS

FIG. 1 is a schematic diagram of a system that performs a method of forming hydrated lime; and

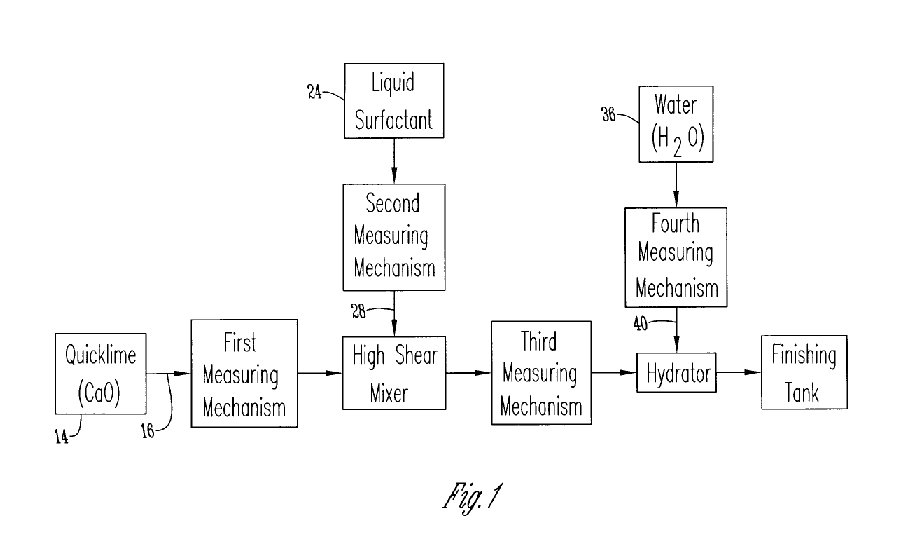

FIG. 2 is a schematic diagram of a method of forming structures utilizing a hydrated lime material.

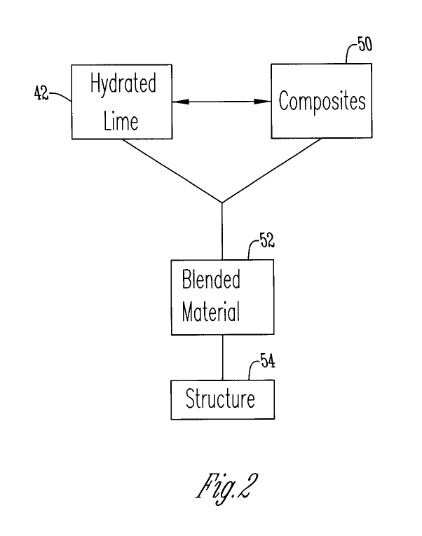

### DETAILED DESCRIPTION OF THE INVENTION

The super hydrated lime process 10 involves the incorporation of an additional step to the hydrated lime production process that is not presently performed. Upon completion of the formation of quicklime 12, through the quicklime formation process, the quicklime 12 is typically conveyed to a storage silo 14 to await delivery as quicklime 12 to customers or for immediate use in the hydration process. The super hydrated lime process 10 adds a circuit to the standard quicklime hydration process.

The super hydrated lime process 10 is as follows, the quicklime 12 (CaO) leaves the storage silo 14 mechanically, such as through a conveyor 16. The quicklime 12 (CaO) is conveyed to a first measuring mechanism 18 which weighs or measures a known quantity of quicklime 12. This known quantity of quicklime 12 is added to at least one mixer 20. Preferably, depending upon size, the mixer 20 is a high shear mixer that can range anywhere between 5 and 200 rpm.

The process includes a liquid surfactant 22, which is stored in a first storage tank 24. The liquid surfactant 22 is conveyed to a second measuring mechanism 26 which weighs or measures a known quantity of liquid surfactant 22. This known quantity of liquid surfactant 22 is added to the mixer 20 through a first dispensing device 28 that in a preferred embodiment is a set of nozzles.

The surfactant 22 is added in a proportion required by the chemistry of the quicklime 12 to ensure the proper and complete coating of the maximum surface area of the quicklime 12 (CaO) possible. The amount of surfactant 22 added is varied as the grain size of finished quicklime 12 (CaO) varies.

In addition, the manner in which the quicklime 12 and surfactant 22 are added to the mixer 20 is also varied. In one arrangement, the full quantity of quicklime 12 and surfactant 22 are added at the same time and mixed together. In another arrangement the full quantity of the quicklime 12 or surfactant 22 is added to the mixer 20 while the other material is slowly added to the mixer 20 while mixing occurs. In another arrangement the quicklime 12 and surfactant 22 are both added at controlled rates to the mixer 20. In one arrangement quicklime 12 and liquid surfactant 22 are added to the mixer 20 in a continuous flow process, where raw materials are continuously going into the mixer 20 and mixed quicklime 12 and liquid surfactant 22 are continuously flowing out of the mixer 20. In another arrangement, quicklime 12 and liquid surfactant 22 are added to the mixer 20 in a batch process, where raw materials are added in batches to at least one mixer 20 and mixed quicklime 12 and liquid surfactant 22 are removed from the mixer 20.

Mixing continues until the surface area of the quicklime 12 is coated with surfactant. While a standard mixing time can be calculated, mixing time can vary depending on variation in the inputs to the process 10. Mixing time depends upon the grain size of quicklime 12 (CaO), quantity of quicklime 12 (CaO) added, impurities in the quicklime 12, amount of surfactant 22 added, the type of surfactant 22 used, manner in which the quicklime 12 and surfactant 22 are added to the mixer 20, the speed, design or manner of operation of the mixer 20, or any other variation in the process including variation in mixer type that satisfies the aforementioned variables.

Next, the quicklime 12 and surfactant 22 mixture is conveyed to a third measuring mechanism 30. The quicklime 12 and surfactant 22 mixture is then weighed or measured and a specified quantity of the quicklime 12 and surfactant 22 mixture is added to a hydrator 32 for initiation of the hydration reaction. Hydration occurs in the hydrator 32 at atmospheric pressure. Alternatively, pressure is added to or contained within the hydrator 32 such that the hydration occurs at higher than atmospheric pressure.

Water, or another hydrating liquid, 34, is stored in a second storage tank 36. The liquid 34 is conveyed to a fourth measuring mechanism 38 which weighs or measures a known quantity of liquid 34. This known quantity of liquid 34 is added to the hydrator 32 through a second dispensing device 40 that in a preferred embodiment is a set of nozzles.

Water or another hydrating liquid 34 is added to the quicklime 12 and surfactant 22 mixture within the hydrator 32. As water 34 is added, a chemical process occurs within the hydrator 32. The heat of the hydration process bonds the carbon chains of the surfactant 22 and quicklime 12 along with the water 34 creating a modified hydrated lime or super hydrated lime 42. The modified chemistry of this material creates a modified product having similar characteristics when added to water as an oil/water mixture. Where the surface tension between the resulting hydrated lime 42 is very high due to the modification of the surface chemistry. The resulting hydrated lime 42 is fully hydrated to the point that the hydrated lime 42 is 90% to 100% insoluble in water and unmixable with water directly.

A properly administered process will result in a 100% insoluble and hydrophobic powder. A process whereby residence times or volumes of additives are not specifically adhered to nets a 90% insoluble hydrophobic powder.

In some arrangements, depending on certain variables in the process 10, resulting hydrated lime 42 is conveyed to a finishing tank 44. Finishing tank is any containment or storage device with mixing that will allow for the final finished product, the hydrated lime 42, to be completely hydrated and therefore allow for the completion of the reaction. The finishing tank 44 may be required in certain existing lime hydration facilities if the existing hydrator 32 does not allowing for the proper time to hydrate the super hydrated lime 42 completely.

The liquid surfactant 22 can be a blend of one or more oils that do not mix with water. Both stability requirements and economics govern the best or optimal blend of surfactant oils to be required for specific applications. Specifically, the following types of surfactants work in this process: alcohols, preferably ethanol or methanol in conjunction with small proportions of detergents with dimethyl siloxane used as an antifoaming agent within the surfactant blend.

It is also possible to blend various cationic and anionic enzymes at varying percentages to modify the chemistry for specific applications as required for the final end product. Surfactants preferably do not contain any percentages of water.

Thus the hydrated lime 42 consists of by volume 0.5-40% (% of total water) surfactant (surface modifier agent mixture) of which 50%-99.5% by volume is oils, including petroleum or non-petroleum oils, new or recycled, 0.5%-50% by volume as catalyst/enzymes and surfactants and detergent regarded for the specified hydration and varies with the surfactant. A water additive in one embodiment is added in multiple steps for both hydration control and quality control of the hydrated lime process. Alternatively a water soluable dimethyl siloxane as an additional coating agent or performance enhancer can be added as desired within the product.

The additional step involved in this process can be incorporated directly into an existing lime hydration facility or can be situated at an offsite production facility. This ultimately depends on the economic benefit derived from the process. Quick lime 12 (CaO) has a much higher density (approximately 60 pcf) than does super hydrated lime 42 which has a density of (approximately 30 pcf), so transportation economics can govern which model is better for the placement of a facility.

Once the hydrated lime 42 is formed the lime may be blended with a plurality of different composites 50 in order to form a blended material 52 that is used to form structures 54 that are impermeable to water. Blended materials 52 include, but are not limited to mulches, formations and any other manner in which the hydrated lime can be mixed or combined with another material or substance. Structures include, but are not limited to load bearing structures, underwater structures, structures used in construction applications, ponds and the like.

The composite materials 50 can include but are not limited to sands, silts, clays, cements, soils, inert process byproduct, slag, mill scales, limestone fines, quarry overburden excavated material, recycled concrete, asphalt and construction materials, other wasted dusts, pozzolans, silica fumes, inert chemical byproducts, inert industrial process byproducts, and the like. When granular sands are the composite 50 the blended material 52 can have for example 10 to 50% by weight of the hydrated lime 42. Tests have shown that such a consistency of granular sand and hydrated lime 42 will not allow water to pass. In another example silts or other fine material when dry, compacted in blends from 5 to 45% by weight hydrated lime 42 are similarly impermeable. In yet another example, clays 5 to 25% by weight hydrated lime 42 exhibit an impermeable blended material 52.

Although these ranges are broad, economics limit using too much of the lime versus other less expensive materials. The goal with the composite blends is to minimize the amount of hydrated lime to the minimum cost without negatively impacting performance.

Blended materials 52 can be custom made or in a standard plant environment. The blended material 52 can be blended onsite using the material with local materials to reduce logistic costs by using a pug mill or other conventional blending equipment. Blends containing cement exhibits a very slow cure time dependent upon the amount of water contact with the blend and the variation of total cement and hydrated lime 42 contact.

The blended material 52 in one embodiment is used to form a structure 54 that is a modified irrigation system used in an agricultural application that directs the flow of water from irrigation or rainfall into specific areas where the use of water results in more efficient utilization of the water. The use of the blended material 52 can thus be used in order to direct water for rows of crops, greenhouses, orchards, vineyards, and the like. In addition, just as the blended material 52 can be utilized to direct water to certain areas, the material can similarly be made to ensure that a reduced amount of water is supplied to different types of crops.

Yet another application of the blended material 52 is to provide a structure 54 that is a pond lining. This can include retention ponds, detention ponds, industrial runoff ponds and any use where water or liquids needs to be stored and can be subject to loss from seepage. Thus, this prevents water from seeping out from the pond.

Another use of the blended material 52 is for chemical spill containment and remediation. Specifically, the hydrated lime 42 has been shown to retain many characteristics of traditional limes and neutralizing certain chemicals and oils. Thus the blended material 52 in one example can be used for beach sand modification prior to contact in neutralization after oil or chemical spills have made it to certain affected spill areas.

In yet another embodiment the structure 54 is a construction base. By using the blended material 52 in association with aggregates or other material to form a construction base an improved reduction of freeze-thaw effects due to base and sub base heave on installations that are within a frozen zone is provided. Thus the reduction in water within the blended aggregate of the construction base prolongs design life for virtually any construction in which a base material is used. Similarly the solid at a construction site can be prepared and mixed with blended material 52 to waterproof the site to prevent construction vehicles from getting stuck in mud and delaying construction.

In yet another embodiment the structure 54 is a road base that is impermeable to water. As a result of being impermeable to water the road will keep water from pooling under the pavement surfaces, whether asphalt or concrete, to reduce long term of freeze-thaw effects that lead to long term degradation of the pavement, as well as prevent wash out of the base material below the road surface.

In yet another embodiment the blended material 52 is utilized to fill cracks within existing roadways, parking lots, surfaces and the like. Again, this prevents water infiltration during seasonal expansions and contractions of both asphaltic and concrete paving gaps and joints as well as in the middle of paving. Specifically, warmer seasons are typically the time when road crews fill cracks and this is simultaneous with the elongation or expansion of the paved surface. During the colder months it is the time when the filled cracks will contract relative to adjacent paving surfaces and break the sealant, thereafter allowing water, ice and chemicals into the cracks and make the cracks larger, constantly worsening the problem. Using the blended material 52 crews can fill cracks during the warm months with expanded pavement with more ease than using tar/petroleum based binders, elasmeric applications, hot mixes, and the like. The blended material 52 is poured in as a dry material, moistened into more of a putty mix, or moistened into a slurry mix and in some cases mixed into a slurry and then left to dry in place. The performance is superior versus other options because as colder months come these blends settle down into the crack as the pavement contracts while all in the while keeping water and ice from directly forming inside the crack. Other options remain rigid and will again crack as the pavement expands and or contracts.

Other structures 54 and uses of the blended material 52 include farm ponds such as fish ponds, and other livestock uses, specialty water applications such as under water applications in construction where the properties of certain blends can be used and water resource preservation such as in arid regions, third world countries that cannot afford to spend money on concrete lined channels over long distances. Other uses include specialty customer applications such as garden uses and yard uses, for LEED certified applications the structure 54 can be a green roof that prevents water infiltration from the watered greenery, focused use of gray water for irrigation. Another application of the blended material 52, adobe bricks that pressed under pressure will remain water resistant indefinitely for use in sustainable construction or in developing variations.

In other embodiments the blended material 52 can be utilized for natural gas and oil sites in order to contain water runoff and remediating the contaminated oil on or around the site. In another application site preparation and land development application are presented where it is determined that a site is needed to remain stable and mostly free from the effects of water blends can be used to effectively keep soil rigid for heavy machine usage providing time savings for construction.

The blended material 52 can additionally be utilized in structures 54 in underground applications including, but not limited to deep foundation usage and excavations. This includes underground utility applications, underground manhole or pipeline water infiltration prevention and conveyance pipeline protection where corrosion needs to be limited underground for steel or concrete structures.

In addition backfill applications that include construction backfill blended to keep water away from specific areas is another application. Yet another application is vegetation control where the blended material 52 will not only prevent moisture but retard the growth of plants and weeds in the areas of application. Flood control structures, levee reinforcements, dams and retaining walls are also contemplated structures 54 within the scope of this disclosure.

Thus presented is a blended material 52 that preserves water resources and enhances new and existing infrastructure through the reduction of seepage, protection from water corrosion damage over time, elimination of freeze-thaw damage, and design focus of water from areas of potential waste of the resource to locations of focused usage. As can be seen, once the hydrated lime 42 is formed the material is used in many applications from civil engineering work to stabilize soils and foundations to specialty water resource preservation to household consumer applications. Thus, at the very least all of the stated objectives have been met.

What is claimed is:

1. A method of forming structures utilizing a hydrated lime material steps comprising:
forming hydrated lime by subjecting quicklime to a mixer and adding a surfactant mixture and water such that the hydrated lime is impermeable to water; and
blending the hydrated lime with a composite material to form a blended material used to form a structure.

2. The method of claim 1 wherein the composite material is selected from a group consisting of sands, silts, clays, soils, cements, pozzolans, silica fumes, mill scales, inert chemical byproducts, inert industrial process byproducts, quarry overburden, and recycled construction materials.

3. The method of claim 1 wherein the blended material is 5 to 50% by weight hydrated lime.

4. The method of claim 1 wherein the structure is an irrigation system.

5. The method of claim 1 wherein the structure is a pond lining.

6. The method of claim 1 wherein the structure is an aggregate material.

7. The method of claim 6 wherein the aggregate material is a construction base.

8. The method of claim 1 wherein the structure is a roadway.

9. The method of claim 1 wherein the blended material is used to contain a chemical spill.

10. The method of claim 1 wherein the blended material is used to fill a crack in a roadway.

11. The method of claim 1 wherein the structure is an underwater structure.

12. The method of claim 1 wherein the structure is a roof.

13. The method of claim 1 wherein the blended material is dried to zero moisture.

14. The method of claim 1 wherein the blended material is moisturized to a predetermined level when applying the blended material to form the structure and is dried after application.

15. The method of claim 1 wherein the blended material is applied to a surface through a water barrier.

16. The method of claim 1 wherein the structure is selected from the group consisting of: flood control structure, levee reinforcement, dam, retaining wall, construction backfill, slope stabilization, landslide mitigation and vegetation growth containment structure.

17. The method of claim 1 wherein the mixer is a high shear mixer.

18. The method of claim 1 where the structure is an underground structure.
